(19) United States
(12) Patent Application Publication
(10) Pub. No.: US 2019/0062514 A1
(43) Pub. Date: Feb. 28, 2019

(54) POLYETHYLENE-BASED RESIN COMPOSITION FOR FOAMABLE LAMINATE, FOAMABLE LAMINATE AND METHOD FOR PRODUCING THE SAME, FOAMED PROCESSED PAPER, AND HEAT INSULATING CONTAINER

(71) Applicant: Japan Polyethylene Corporation, Chiyoda-ku (JP)

(72) Inventors: Keiichi SASAKI, Kanagawa (JP); Shinji SAKAMOTO, Kanagawa (JP)

(73) Assignee: Japan Polyethylene Corporation, Chiyoda-ku (JP)

(21) Appl. No.: 16/080,445

(22) PCT Filed: Feb. 28, 2017
(86) PCT No.: PCT/JP2017/008008

§ 371 Date: Aug. 28, 2018

(30) Foreign Application Priority Data
Feb. 29, 2016 (JP) 2016-037385

(51) Int. Cl. C08J 9/04; B32B 27/32; B32B 27/10; B32B 5/18; B65D 65/40; C08F 10/02

(52) U.S. Cl. CPC C08J 9/04; B32B 27/32; B32B 27/10; B32B 5/18; B65D 65/40; C08J 2323/08; B32B 2439/00; B32B 2307/304; C08J 2201/03; C08J 2323/06; C08F 10/02

(57) ABSTRACT

The present invention provides a polyethylene-based resin composition for a foamable laminate which contains a polyethylene-based resin (A) satisfying the following properties (a-1) to (a-3): (a-1) MFR is 6 g/10 minutes or more and less than 20 g/10 minutes; (a-2) the density is from 0.920 to 0.930 g/cm³; and (a-3) the ratio of eluates at an elution temperature of 70° C. or higher is from 47 to 83% by weight in the elution curve obtained by a temperature rising elution fractionation (TREF) with o-dichlorobenzene.

### TECHNICAL FIELD

The present invention relates to a polyethylene-based resin composition for a foamable laminate, a foamable laminate and a method for producing the same, a foamed processed paper, and a heat insulating container. More specifically, it relates to a polyethylene-based resin composition for a foamable laminate, a foamable laminate and a method for producing the same, a foamed processed paper, and a heat insulating container, which, by heating, give foamed cells having sufficient height and good appearance (foamed layer) with good productivity and is excellent in microwave oven suitability.

### BACKGROUND ART

Heretofore, as a container having heat insulating properties, synthetic resin-made foamed products have been frequently used. As a container that is easy to dispose and has good printability, there are known a heat insulating paper container which uses plural sheets of paper and a paper container which uses a material of a paper substrate both sides of which are laminated with a polyethylene-based resin layer and has heat insulating properties imparted by foaming the polyethylene-based resin layer on the surface.

As a technique of using paper as a substrate, there is known a technique of extrusion-laminating polyethylene on at least one side of paper, forming a vapor pressure-retaining layer on the other side thereof, and heating it, thereby producing a processed paper having an irregular embossed pattern on the surface thereof (for example, see Patent Literature 1).

Moreover, there is proposed a technique of laminating or attaching a thermoplastic resin film on the wall surface on one side of a body part and subsequently heating it to foam the film, thereby forming a foamed heat insulating layer (for example, see Patent Literature 2).

Also, in a paper-made container composed of a container body part and a bottom part, there is proposed a technique of printing a part of the outer wall surface of the container body part with an organic solvent-containing ink, covering all the outer wall surface of the body part with a thermoplastic synthetic resin film, and heating the resulting paper container, thereby providing a relatively thick foamed layer in the printed portion (for example, see Patent Literature 3).

Further, there is proposed a foamed processed paper composed of a laminate that comprises at least an ethylene-α-olefin copolymer produced through polymerization with a single-site catalyst from the outer face side thereof, or a foamed layer containing the copolymer, a substrate layer mainly composed of paper, and a thermoplastic resin layer (for example, see Patent Literatures 4, 5). The thus-obtained processed paper having a foamed layer has, when the paper is transformed into a container, advantages in that they fit comfortably in hand and hardly slip and they are excellent in heat insulating properties owing to the foamed layer, and also, as compared with heat insulating containers that use plural sheets of paper, they cost low.

Patent Literature 6 shows a body part material sheet for paper-made containers, in which a thermoplastic resin in a molten state is extrusion-laminated on at least one side of the paper substrate of the body part material sheet in the paper container in such a manner that a period of time required for traveling the resin from the T-die to the contact with the paper substrate is controlled to from 0.11 to 0.33 seconds, and the literature describes a composition whose MFR is controlled by mixing two types of low-density polyethylene.

However, with regard to conventional laminates having a foamable layer and processed paper that uses the same, in the case where a processing speed is made a certain rate or more at the time of extrusion lamination, there occurs a problem that the appearance may worsen at the time of foaming by heating. Therefore, there is desired such an improvement that foamed cells having sufficient height and good appearance are formed by heating even in the case where the processing speed at the extrusion lamination is made high.

On the other hand, recently, a container having such heat insulating properties has been widely used as a container for microwave oven cooking. However, the conventional container has a problem of poor microwave oven suitability. That it, there are problems that the foamed cells are enlarged and communicated with each other to generate a phenomenon of protruding the surface of the foamed layer (blister formation) and the enlarged foamed cells are broken through the blister formation to generate irregularities on the surface, thereby impairing the appearance.

Therefore, there is proposed a technique that a polyethylene-based resin layer having specific density (A)/a substrate layer/a foamed layer having specific density (B) are included, high-pressure process low density polyethylene is used as a polyethylene-based resin constituting the layer (B), and the thickness of the layer (A) and the thickness of the layer (B) before and after foaming are defined (for example, see Patent Literature 7).

However, in the conventional container for microwave oven cooking having heat insulating properties, in the case where the processing speed is made high, the appearance may worsen at the time of foaming by heating and the container has not yet reached the level required in the art, so that there is room for improvement.

### CITATION LIST

### Patent Literatures

### Patent Literature 1: JP-B-48-32283

### Patent Literature 2: JP-A-57-110439

### Patent Literature 3: JP-A-07-232774

### Patent Literature 4: JP-A-10-128928

### Patent Literature 5: JP-A-2007-168178

### Patent Literature 6: JP-A-2008-105747

### Patent Literature 7: Japanese Patent No. 5707848

### SUMMARY OF THE INVENTION

### Problems that the Invention is to Solve

In consideration of the above-mentioned problems, an object of the invention is to provide a polyethylene-based resin composition for a foamable laminate, a foamable laminate and a method for producing the same, a foamed processed paper, and a heat insulating container, which, by heating, give foamed cells having sufficient height and good appearance (foamed layer) with good productivity and is excellent in microwave oven suitability.

### Means for Solving the Problems

As a result of extensive and intensive studies for solving the above problems, the present inventors have found that, in a polyethylene-based resin composition for a foamable laminate, which is used for forming a polyethylene-based resin layer (I) for foaming on at least one side of a substrate mainly composed of paper, the above problems can be solved by specifying the properties of a polyethylene-based resin (A) contained in the composition. Thus, they have accomplished the present invention.

The present invention is as follows.

1. A polyethylene-based resin composition for a foamable laminate, which forms a polyethylene-based resin layer (I) for foaming on at least one side of a substrate mainly composed of paper, wherein the polyethylene-based resin composition for foamable laminate contains a polyethylene-based resin (A) satisfying the following properties (a-1) to (a-3):

(a-1) the melt flow rate MFR as measured in accordance with JIS K7210:1999 (190° C., a load of 21.18N) is 6 g/10 minutes or more and less than 20 g/10 minutes,

(a-2) the density as measured in accordance with JIS K7112:1999 at a test temperature of 23° C. is from 0.920 to 0.930 g/cm³, and

(a-3) the ratio of eluates at an elution temperature of 70° C. or higher is from 47 to 83% by weight in the elution curve obtained by a temperature rising elution fractionation (TREF) with o-dichlorobenzene.

2. The polyethylene-based resin composition for a foamable laminate according to the item 1 above, wherein the polyethylene-based resin (A) is at least one selected from a high-pressure radical polymerization process low-density polyethylene and an ethylene copolymer.

3. The polyethylene-based resin composition for a foamable laminate according to the item 2 above, wherein the polyethylene-based resin composition for a foamable laminate contains the high-pressure radical polymerization process low-density polyethylene as the polyethylene-based resin (A) and an ethylene-α-olefin copolymer.

4. The polyethylene-based resin composition for a foamable laminate according to any one of the items 1 to 3 above, which is for microwave oven cooking.

5. A foamable laminate comprising a polyethylene-based resin layer (I) for foaming on at least one side of a substrate mainly composed of paper, wherein the polyethylene-based resin layer (I) is composed of the polyethylene-based resin composition for a foamable laminate according to any one of the items 1 to 4 above.

6. The foamable laminate according to the item 5 above, which comprises a thermoplastic resin layer (II) which keeps steam released from the substrate at the time of foaming on the other side of the substrate, wherein a thermoplastic resin (B) contained in the thermoplastic resin layer (II) satisfies the following property (b-1):

(b-1): the melting point (Tm(b)) falls within a range of from 100 to 140° C.

7. The foamable laminate according to the item 6 above, wherein the melting point (Tm(a)) of the polyethylene-based resin (A) and the melting point (Tm(b)) of the thermoplastic resin (B) satisfy the following property (b-2):

(b-2): Tm(b)−Tm(a) is 10° C. or more.

8. A method for producing a foamable laminate comprising a polyethylene-based resin layer (I) for foaming on at least one side of a substrate mainly composed of paper, wherein the polyethylene-based resin layer (I) is formed by extrusion lamination of the polyethylene-based resin composition for a foamable laminate according to any one of the items 1 to 4 above on at least one side of the substrate.

9. The method for producing a foamable laminate according to the item 8 above, wherein the processing speed of the extrusion lamination is 55 m/minute or more.

10. A foamed processed paper, wherein the polyethylene-based resin layer (I) of the foamable laminate according to any one of the items 5 to 7 above is in a foamed state.

11. A heat insulating container, wherein the polyethylene-based resin layer (I) of the foamable laminate according to any one of the items 5 to 7 above is in a foamed state.

### Advantage of the Invention

The polyethylene-based resin composition for a foamable laminate of the present invention forms a polyethylene-based resin layer (I) for foaming on at least one side of a substrate mainly composed of paper and, since properties of a polyethylene-based resin (A) contained in the composition, i.e., MFR, density, and the ratio of eluates in the elution curve obtained by TREF are specified, even in the case where the processing speed at the time of laminate forming is made high, foamed cells having sufficient height and good appearance (foamed layer) can be obtained with good productivity by heating.

Also, the resin composition can solve the problems that the foamed cells are enlarged and communicated with each other to generate a phenomenon of protruding the surface of the foamed layer (blister formation) and the enlarged foamed cells are broken through the blister formation to generate irregularities on the surface, thereby impairing the appearance, and is excellent in so-called microwave oven suitability.

Since the foamable laminate of the present invention comprises the polyethylene-based resin layer (I) composed of the polyethylene-based resin composition for a foamable laminate of the invention, even in the case where the processing speed at the time of laminate forming is made high, foamed cells having sufficient height and good appearance (foamed layer) can be obtained by heating with good productivity (hereinafter sometimes referred to as “foamability”) and the laminate is excellent in the microwave oven suitability.

In the method for producing a foamable laminate of the present invention, since the polyethylene-based resin layer (I) composed of the polyethylene-based resin composition for a foamable laminate is formed by extrusion lamination on a substrate, foamed cells having sufficient height and good appearance (foamed layer) can be obtained by heating with good productivity.

Since the foamed processed paper and the heat insulating container of the present invention are obtained by foaming the foamable laminate, they have good appearance of foaming and also are excellent in the microwave oven suitability.

### MODES FOR CARRYING OUT THE INVENTION

The following will describe the polyethylene-based resin composition for a foamable laminate, the foamable laminate and the method for producing the same, the foamed processed paper, and the heat insulating container of the present invention in detail.

### 1. Polyethylene Resin-Based Composition for Foamable Laminate

The polyethylene-based resin composition for a foamable laminate of the present invention contains a polyethylene-based resin (A) as an essential component and the polyethylene-based resin (A) satisfies the following properties (a-1) to (a-3):

(a-1) the melt flow rate MFR as measured in accordance with JIS K7210:1999 (190° C., a load of 21.18N) is 6 g/10 minutes or more and less than 20 g/10 minutes,

(a-2) the density as measured in accordance with JIS K7112:1999 at a test temperature of 23° C. is from 0.920 to 0.930 g/cm³, and

(a-3) the ratio of eluates at an elution temperature of 70° C. or higher is from 47 to 83% by weight in the elution curve obtained by temperature rising elution fractionation (TREF) with o-dichlorobenzene.

As the polyethylene-based resin (A), there may be exemplified ethylene homopolymer, high-pressure radical polymerization process low-density polyethylene, ethylene/α-olefin copolymers, polyolefins such as polypropylene, and mixtures thereof. As a raw material, either one using plant-derived ethylene or one using petroleum-derived ethylene may be used.

As monomers to be copolymerized with ethylene in the ethylene copolymers, for example, there may be exemplified conjugated dienes (for example, butadiene and isoprene), non-conjugated dienes (for example, 1,4-pentadiene), acrylic acid, acrylic acid esters (for example, methyl acrylate and ethyl acrylate), methacrylic acid, methacrylic acid esters (for example, methyl methacrylate and ethyl methacrylate), vinyl acetate ethylene, and the like.

Of these, preferred is high-pressure radical polymerization process low-density polyethylene or an ethylene copolymer. The high-pressure radical polymerization process low-density polyethylene is produced by bulk or solution polymerization using a radical initiator such as oxygen or an organic peroxide under ultrahigh pressure of from 1000 to 4000 atm.

Moreover, a mixture of the high-pressure radical polymerization process low-density polyethylene and an ethylene/α-olefin copolymer is also preferred. In this case, the ratio (weight ratio) of the high-pressure radical polymerization process low-density polyethylene to the ethylene/α-olefin copolymer is preferably from 1:9 to 5:5, further preferably from 1:9 to 3:7 as the former:the latter.

As the resin (A), for example, there may be used one prepared by adding a radical generator to the high-pressure radical polymerization process low-density polyethylene and performing a radical reaction.

Examples of the radical generator include organic peroxides, dihydroaromatics, dicumyl compounds, and the like. Examples of the organic peroxides include (i) hydroperoxides such as t-butyl hydroperoxide, cumene hydroperoxide, and 1,1,3,3-tetramethylbutyl hydroperoxide; (ii) ketone peroxides such as methyl ethyl ketone peroxide, methyl isobutyl ketone peroxide, acetylacetone peroxide, and cyclohexanone peroxide; (iii) diacyl peroxides such as isobutyryl peroxide, lauroyl peroxide, and benzoyl peroxide; (iv) dialkyl peroxides such as dicumyl peroxide, 2,5-dimethyl-2,5-di(t-butylperoxy)hexane, t-butylcumyl peroxide, di-t-butyl peroxide, 2,5-dimethyl-2,5-di-(t-butylhexyne)-3, and di-t-amyl peroxide; (v) peroxyketals such as 2,2-di-(t-butylperoxy)butane; (vi) alkyl peresters such as t-hexyl peroxypivalate, t-butyl peroxypivalate, t-amyl peroxy2-ethylhexanoate, t-butyl peroxy2-ethylhexanoate, t-butyl peroxyisobutyrate, and t-butyl peroxybenzoate; (vii) percarbonates such as bis(4-t-butylcyclohexyl) peroxy dicarbonate, diisopropyl peroxy dicarbonate, and t-amyl peroxy isopropyl carbonate; (viii) cyclic organic peroxides such as 3,6,9-triethyl-3,6,9-trimethyl-1,4,7-triperoxonan. Of these, preferred are cyclic organic peroxides.

The amount of the organic peroxide to be blended is not particularly limited but is preferably 0.5 parts by weight or less, particularly preferably 0.1 parts by weight or less relative to 100 parts by weight of the resin. When the amount of the organic peroxide to be blended exceeds 0.5 parts by weight, the flowability becomes worse.

For the radical reaction, there is suitably used a melt reaction method of melt-kneading the resin and the radical generator simultaneously in an extruder to react them or a solution reaction method of dissolving the resin and the radical generator in an organic solvent and reacting them while heating, mixing, and stirring.

(a-1) Melt Flow Rate MFR

MFR of the polyethylene-based resin (A) in the present invention is 6 g/10 minutes or more and less than 20 g/10 minutes. When this requirement is not satisfied, in the case where the processing speed at the time of laminate forming is made high, foamed cells having sufficient height and good appearance (foamed layer) are not obtained by heating.

Further preferable MFR is from 9 to 20 g/l 0 minutes and particularly preferable MFR is from 9 to 15 g/10 minutes.

Here, MFR means a value as measured in accordance with JIS-K7210:1999 (190° C., a load of 21.18N). Moreover, in the case where the polyethylene-based resin (A) is a mixture, it is sufficient that MFR of the mixture satisfies the above range.

(a-2) Density

The density of the polyethylene-based resin (A) in the present invention is from 0.920 to 0.930 g/cm³. When this requirement is not satisfied, it is impossible to satisfy good foamability and microwave oven suitability simultaneously.

Further preferable density is from 0.920 to 0.928 g/cm³ and particularly preferable density is from 0.920 to 0.925 g/cm³.

Here, the density means a value as measured at a test temperature of 23° C. in accordance with JIS K7112:1999. Moreover, in the case where the polyethylene-based resin (A) is a mixture, it is sufficient that the density of the mixture satisfies the above range.

(a-3) Eluates

In the polyethylene-based resin (A) in the invention, the ratio of eluates at an elution temperature of 70° C. or higher is from 47 to 83% by weight in the elution curve obtained by temperature rising elution fractionation (TREF) with o-dichlorobenzene. Unless the requirement is satisfied, the good foamability and the microwave oven suitability cannot be simultaneously satisfied.

Further, the ratio of the eluates is preferably from 50 to 80% by weight and particularly preferable ratio of the eluates is from 60 to 80% by weight. Incidentally, in the case where the polyethylene-based resin (A) is a mixture, it is sufficient that the eluates of the mixture satisfy the above range.

Here, the ratio of the eluates is measured by the following method.

A sample is dissolved in o-dichlorobenzene (containing 0.5 mg/mLBHT) at 140° C. to form a solution. After it is introduced into a TREF column at 140° C., it is cooled to 100° C. at a temperature-lowering rate of 8° C./minute, subsequently cooled to 40° C. at a temperature-lowering rate of 4° C./minute, further subsequently cooled to −15° C. at a temperature-lowering rate of 1° C./minute, and then kept for 20 minutes. Thereafter, o-dichlorobenzene (containing 0.5 mg/mLBHT) as a solvent is allowed to flow through the column at a flow rate of 1 mL/minute to elute components dissolved in o-dichlorobenzene at −15° C. in the TREF column for 10 minutes and then the column is linearly heated to 140° C. at a temperature-elevating rate of 100° C./hour to obtain an elution curve.

The devices and measurement conditions are, for example, as follows.

### (TREF Part)

TREF column: stainless steel column of 4.3 mmϕ×150 mm

Column packing material: surface inactivated glass beads of 100 μm

Heating method: aluminum heat block

Cooling method: Peltier element (water cooling is used for cooling the Peltier element)

Temperature distribution: +0.5° C.

Temperature controller: digital programmed controller KP1000 manufactured by Chino Corporation

### (Valve Oven)

Heating method: air bath-type oven

Temperature at measurement: 140° C.

Temperature distribution: ±1° C.

Valve: six-way valve, four-way valve

### (Sample Injection Part)

Injection method: loop injection method

Injection amount: loop size 0.1 ml

Injection port heating method: aluminum heat block

Temperature at measurement: 140° C.

### (Detection Part)

Detector: wavelength fixed-type infrared detector MIRAN 1A manufactured by FOXBORO

Detection wavelength: 3.42 μm

High-temperature flow cell: micro flow cell for LC-IR

Optical path length: 1.5 mm, window shape of 2ϕ×4 mm long round shape, synthetic sapphire widow plate

Temperature at measurement: 140° C.

### (Pump Part)

Liquid-feeding pump: SSC-3461 pump manufactured by Senshu Scientific Co., Ltd.

### <Measurement Conditions>

Solvent: o-dichlorobenzene (containing 0.5 mg/mLBHT)

Sample concentration: 5 mg/mL

Sample injection amount: 0.1 mL

Solvent flow rate: 1 mL/minute

The polyethylene resin composition for a foamable laminate in the invention may contain additives such as phenol-based and phosphorus-based antioxidants, neutralizers such as metal soap, antiblocking agents, lubricants, dispersants, colorants such as pigments and dyes, antifogging agents, antistatic agents, UV absorbents, light stabilizers, and nucleating agents within ranges where the properties of the polyethylene-based resin (A) are not impaired.

In addition, within a range where the properties of the polyethylene-based resin (A) are not impaired, any other thermoplastic resin may be blended into the resin composition. As the thermoplastic resin, there may be mentioned other polyolefin resins, polyester resins, polyvinyl chloride resin, polystyrene resin, and the like.

Since the polyethylene-based resin composition for a foamable laminate of the invention is particularly excellent in the microwave oven suitability, it is preferably for microwave oven cooking.

### 2. Foamable Laminate

The foamable laminate of the invention comprises a polyethylene-based resin layer (I) for foaming on at least one side of a substrate mainly composed of paper, and the polyethylene-based resin layer (I) is composed of the polyethylene resin composition for a foamable laminate as described above.

### (1) Substrate Mainly Composed of Paper

In the invention, the substrate mainly composed of paper (hereinafter sometimes referred to as “paper substrate”) is not particularly limited so long as it can foam the polyethylene-based resin layer (I) on the surface by a vapor or a volatile matter contained in the paper substrate.

For example, there may be mentioned high-quality paper, kraft paper, art paper, and the like. The paper substrate may be coated with a substance that generates a volatile gas by heating, or a substance that generates a volatile gas by heating may be blended into the paper substrate. In the paper substrate, figures, letters, patterns or the like may be printed with ink or the like on paper such as pulp paper or synthetic paper. The paper used for the substrate preferably has a unit weight of from 100 to 400 g/m², particularly preferably from 150 to 350 g/m². The water content of the paper is, for example, from 4 to 10%, preferably from 5 to 8% or so. The paper substrate may be subjected to printing thereon.

### (2) Polyethylene-Based Resin Layer (I)

For the resin constituting the polyethylene-based resin layer (I) in the invention, the above polyethylene-based resin (A) can be used. For forming uniform foamed cells at a high expansion ratio, the polyethylene-based resin (A) is preferably selected so as to have a melting point falling within a range of from 80 to 120° C., preferably within a range of from 90 to 110° C. or so.

The thickness of the polyethylene-based resin layer (I) in the invention is not particularly limited but is, for example, from 20 to 100 μm and, from the viewpoint of increasing the thickness of the foamed layer, is preferably from 30 to 100 μm. When the thickness of the polyethylene-based resin layer (I) is less than 20 μm, it is difficult to make the thickness of the foamed layer sufficiently high.

If necessary, the polyethylene-based resin layer (I) in the invention may be subjected to printing or the like thereon. The printing may be partially or entirely performed with a color ink. For the position to be printed, the size of the area to be printed, the printing method, the ink to be used, and the like, conventionally known techniques may be suitably selected and used.

On the foamable laminate of the invention, a thermoplastic resin layer (II) which retains the vapor released from the paper substrate at the time of foaming may be provided on a side of the paper substrate (the other side of the paper substrate) reverse to the side on which the polyethylene-based resin layer (I) is formed. The thermoplastic resin layer (II) contains the following thermoplastic resin (B).

The thermoplastic resin (B) may be a resin having a higher melting point than that of the polyethylene-based resin (A) or a non-melting resin and is not particularly limited. In order to preferentially foam the polyethylene-based resin layer (I) to easily obtain uniform and high cell thickness, the thermoplastic resin (B) preferably satisfies the following property (b-1):

(b-1): the melting point (Tm(b)) falls within a range of from 100 to 140° C.

Here, the melting point in the present invention is measured as follows.

Pellets are hot-pressed into a sheet, and punched with a punch to give a sample. Measurement is performed in accordance with the method of JIS K7121-1987. It is performed under the following conditions in a sequence of first temperature elevation, temperature lowering, and second temperature elevation, and the temperature at the maximum peak height during the second temperature elevation is taken as Tm.

Device: DSC (DSC7020) manufactured by SII Nanotechnology

### Temperature Elevation/Temperature Lowering Conditions:

First Temperature Elevation: from 30° C. to 200° C. at 10° C./minute

Temperature Lowering: from 200° C. to 20° C. at 10° C./minute

Second Temperature Elevation: from 20° C. to 200° C. at 10° C./minute

Temperature Retaining Time: 5 minutes after the first temperature elevation, and 5 minutes after the temperature lowering

Sample Amount: 5 mg

Temperature Calibration: indium

Reference: aluminum

Moreover, the thermoplastic resin (B) further preferably satisfies the following property (b-2):

(b-2): Tm(b)−Tm(a) is 10° C. or more

wherein Tm(a) is the melting point (° C.) of the polyethylene-based resin (A) and Tm(b) is the melting point (° C.) of the thermoplastic resin (B).

By satisfying the above property (b-2), a foamed layer having uniform and sufficient height of foaming is obtained.

Examples of the thermoplastic resin (B) for use in the invention include polyolefin-based resins such as α-olefin homopolymers having 2 to 10 carbon atoms and their mutual copolymers, such as high-density polyethylene, medium-density polyethylene, low-density polyethylene, ethylene copolymers, polypropylene-based resin, polybutene-1 resin, and poly-4-methyl-pentene-1 resin; polyamide-based resins; polyester-based resins; saponified products of ethylene-vinyl acetate copolymers; vinyl chloride resins; vinylidene chloride resins; polystyrene resins; and their mixtures, and the like. As monomers that copolymerize with ethylene in the ethylene copolymers, there may be exemplified conjugated dienes (for example, butadiene and isoprene), non-conjugated dienes (for example, 1,4-pentadiene), acrylic acid, acrylic acid esters (for example, methyl acrylate and ethyl acrylate), methacrylic acid, methacrylic acid esters (for example, methyl methacrylate and ethyl methacrylate), vinyl acetate ethylene, and the like.

Of these, polyolefin-based resins such as high-density polyethylene, medium-density polyethylene, and linear low-density polyethylene are preferred.

In the case where a polyethylene-based resin is employed as the thermoplastic resin (B), MFR is from 0.1 to 100 g/10 minutes, preferably from 0.3 to 80 g/10 minutes, more preferably from 0.5 to 60 g/10 minutes and the density is from 0.920 to 0.970 g/cm³, preferably from 0.925 to 0.960 g/cm³, more preferably from 0.930 to 0.950 g/cm³ or so.

In the case where a resin poorly adhesive to the paper substrate, such as a polyamide-based resin, a polyester-based resin, a saponified product of ethylene/vinyl acetate copolymer, vinyl chloride resin, vinylidene chloride resin, or polystyrene resin is used, a laminate may be formed through an ordinary adhesive resin or the like, such as an unsaturated carboxylic acid-modified polyolefin resin, an ethylene/unsaturated carboxylic acid copolymer or the like.

If necessary, into the thermoplastic resin (B), there may be blended additives such as phenol-based and phosphorus-based antioxidants, neutralizers such as metal soap, antiblocking agents, lubricants, dispersants, colorants such as pigments and dyes, antifogging agents, antistatic agents, UV absorbents, light stabilizers, and nucleating agents within ranges where the properties of the thermoplastic resin are not impaired.

The thickness of the thermoplastic resin layer (II) is not particularly limited but is preferably selected generally from a range of from 10 to 100 μm, particularly from a range of from 20 to 100 μm, from the viewpoint of capability of increasing the thickness of the foamed layer after foaming of the polyethylene-based resin layer (I). When the thickness of the thermoplastic resin layer (II) is less than 10 μm, there is a concern that the layer cannot fully retain the vapor or the like released from the paper substrate and the thickness of the foamed layer cannot be made sufficiently high. Moreover, when it exceeds 100 μm, any more improved effect cannot be expected and there is a concern that economical disadvantage may increase.

In the foamable laminate of the invention, within a range where the advantage of the invention is not impaired, any other layer may be provided between the layers of the laminate or as an additional inner layer and/or outer layer or the like. For example, one or more film layers, decorative layers, reinforcing layers, adhesive layers, barrier layers, or the like may be provided as additional inner layer(s) and/or outer layer(s) of the laminate in which the substrate and the polyethylene-based resin layer (I) and further the thermoplastic resin layer (II) are provided, or between these layers, like {polyethylene film layer/polyethylene-based resin layer (I)/paper substrate/thermoplastic resin layer (II)}, {polyethylene film layer/barrier layer/adhesive layer/polyethylene-based resin layer (I)/paper substrate/thermoplastic resin layer (II)}, {polyethylene-based resin layer (I)/paper substrate/thermoplastic resin layer (II)/barrier layer/thermoplastic resin layer (II)}, from the outside.

If necessary, the laminate may be subjected to printing or the like thereon. Printing may be performed with a color ink, partly or entirely on the surface thereof. Also, if necessary, using a foamable ink, a foamable site may be provided partly or entirely thereon. For the position to be printed, the size of the area to be printed, the printing method, the printing ink, and the like, conventionally known techniques may be suitably selected and used.

Examples of the decorative layer include printed paper, film, non-woven fabric, woven fabric, and the like.

Moreover, the reinforcing layer is a layer that plays roles of preventing the foamed layer from bursting owing to excessive foaming and uniformly correcting uneven foamed cells, which is effected by laminating a polyethylene resin film or the like as an outer layer on the polyethylene-based resin layer (I) so that the foamed layer does not burst at the time of foaming by heating the polyethylene-based resin layer (I) having been laminated on the substrate, or a role of enhancing the mechanical strength, which is effected by laminating a film, a non-woven fabric, or the like thereon. The resin is not particularly limited and may be a polyolefin-based resin such as polyethylene or polypropylene, a polyamide-based resin, a polyester-based resin, or the like.

As a resin forming the adhesive layer, there may be mentioned a hot-melt such as a copolymer of ethylene with an unsaturated carboxylic acid or its derivative, a modified polyolefin resin of a polyolefin resin grafted with an unsaturated carboxylic acid or the like, or an ethylene/vinyl acetate copolymer and ordinary adhesives.

As a resin forming the barrier layer, there may be mentioned polyamide-based resins, polyester-based resins, saponified products of ethylene/vinyl acetate copolymer (EVOH), polyvinylidene chloride resins, polycarbonate-based resins, oriented polypropylene (OPP), oriented polyesters (OPET), oriented polyamides, inorganic oxide-deposited films such as alumina-deposited film and silica-deposited film, metal-deposited films such as aluminum-deposited film, metal foils, and the like.

Since the polyethylene-based resin composition for a foamable laminate of the invention is particularly excellent in the microwave oven suitability, the composition is preferably for microwave oven cooking.

### 3. Method for Producing Foamable Laminate

The method for producing the foamable laminate of the invention comprises a step of extrusion lamination of the polyethylene resin composition for a foamable laminate on at least one side of the paper substrate to form the polyethylene-based resin layer (I).

The extrusion lamination is a method of continuously applying and press-adhering a molten resin film extruded out through a T-die, onto a substrate, and this is a forming method of achieving application and adhesion at a time. The extrusion lamination is preferably performed at a processing speed of 55 m/min or more and, from the viewpoint of productivity, further preferably at a processing speed of 65 m/min or more.

4. Foamed Processed paper

The foamed processed paper of the invention is obtained by foaming the polyethylene-based resin layer (I). The height of the foamed cells of the foamed processed paper is preferably 370 μm or more, more preferably 400 μm or more. When the height of the foamed cells is less than 370 m, sufficient heat insulating properties are not obtained.

The heating method is not particularly limited but there may be mentioned methods of heating with hot air, microwaves, high frequency waves, IR rays, far-IR rays, and the like. The heating temperature is not particularly limited but must be a temperature at which moisture in the paper substrate is evaporated away and the polyethylene-based resin (A) melts; thus, for example, the temperature is preferably from 100 to 140° C. The heating time is preferably from 10 seconds to 5 minutes. Within the above ranges, sufficient height of foamed cells is easily obtained.

The foamed processed paper is used needless-to-say as heat insulating/heat retaining materials for heat insulating containers such as cups to be mentioned below, and also as cushioning materials, sound insulating materials, formed papers, etc.; and is put to practical use as agricultural, industrial and household materials such as sleeve materials, paper dishes, trays, antislip materials, packaging materials for fruits, and foamed papers. Since the foamed processed paper of the invention is particularly excellent in the microwave oven suitability, the foamed processed paper is preferably for microwave oven cooking.

### 5. Heat Insulating Container

The heat insulating container of the invention is obtained by shaping the above-mentioned foamable laminate into a container, then heating the container, and foaming the polyethylene-based resin layer (I).

Also in the heat insulating container, as in the above-mentioned foamed processed paper, the height of the foamed cells is preferably 370 μm or more, more preferably 400 μm or more. When the height of the foamed cells is 370 μm or more, sufficient heat insulating properties are easily obtained.

The thus obtained heat insulating container is used as trays, cups, and the like but, since the heat insulating container of the invention is particularly excellent in the microwave oven suitability, the heat insulating container is preferably for microwave oven cooking.

### EXAMPLES

Hereinafter, the present invention will be described more specifically with reference to Examples but the invention is not limited to these Examples. Incidentally, test methods for physical properties and obtained foamed laminates and the like in the present Examples are as follows.

(1) MFR: It was measured in accordance with JIS K7210:1999 (190° C., a load of 21.18 N).
(2) Density: Pellets were hot-pressed into a pressed sheet having a thickness of 2 mm, the sheet was put into a 1000-ml beaker which was then filled with distilled water, and the beaker was covered with a watch glass and heated with a mantle heater. After the distilled water began to boil, it was boiled for 60 minutes and then the beaker was put on a wood rack and left to cool thereon.

At this time, the amount of the distilled water after boiled for 60 minutes was controlled to 500 ml and the time required for cooling to room temperature was controlled so as not to be 60 minutes or shorter. The test sheet was immersed nearly in the central part of water so as not to be in contact with the beaker and the water surface. The sheet was annealed under the conditions of 23° C. and a humidity of 50% for a period of 16 hours or more and 24 hours or less and then punched to give a piece of 2 mm (length)×2 mm (width). The punched one was measured at a test temperature of 23° C. in accordance with JIS-K7112:1999.

(3) Ratio of Eluates (% by weight): A sample was dissolved in o-dichlorobenzene (containing 0.5 mg/mLBHT) at 140° C. to form a solution. After it was introduced into a TREF column at 140° C., it was cooled to 100° C. at a temperature-lowering rate of 8° C./minute, subsequently cooled to 40° C. at a temperature-lowering rate of 4° C./minute, further subsequently cooled to −15° C. at a temperature-lowering rate of 1° C./minute, and then kept for 20 minutes. Thereafter, o-dichlorobenzene (containing 0.5 mg/mLBHT) as a solvent was allowed to flow through the column at a flow rate of 1 mL/minute to elute components dissolved in o-dichlorobenzene at −15° C. in the TREF column for 10 minutes and then the column was linearly heated to 140° C. at a temperature-elevating rate of 100° C./hour to obtain an elution curve.

The device and measurement conditions are as follows.

### (TREF Part)

TREF column: stainless steel column of 4.3 mmϕ×150 mm

Column packing material: surface inactivated glass beads of 100 μm

Heating method: aluminum heat block

Cooling method: Peltier element (water cooling is used for cooling the Peltier element)

Temperature distribution: +0.5° C.

Temperature controller: digital programmed controller KP1000 manufactured by Chino Corporation

### (Valve Oven)

Heating method: air bath-type oven

Temperature at measurement: 140° C.

Temperature distribution: ±1° C.

Valve: six-way valve, four-way valve

### (Sample Injection Part)

Injection method: loop injection method

Injection amount: loop size 0.1 ml

Injection port heating method: aluminum heat block

Temperature at measurement: 140° C.

### (Detection Part)

Detector: wavelength fixed-type infrared detector MIRAN 1A manufactured by FOXBORO

Detection wavelength: 3.42 μm

High-temperature flow cell: micro flow cell for LC-IR

Optical path length: 1.5 mm, window shape of 2ϕ×4 mm long round shape, synthetic sapphire widow plate

Temperature at measurement: 140° C.

### (Pump Part)

Liquid-feeding pump: SSC-3461 pump manufactured by Senshu Scientific Co., Ltd.

<Measurement Conditions>

Solvent: o-dichlorobenzene (containing 0.5 mg/mLBHT)

Sample concentration: 5 mg/mL

Sample injection amount: 0.1 mL

Solvent flow rate: 1 mL/minute

### (4) Height of Foaming

A laminate obtained in Example or Comparative Example was cut into a piece of 10 cm×10 cm and was allowed to stand for 360 seconds in a perfect oven (PH-102 type manufactured by Espec) heated at 120° C. Thereafter, the sample was taken out and cooled to room temperature in the air. The cross-section of the foamed layer of the laminate after foaming was photographed with a digital microscope, then the height of the foamed layer alone was measured at 10 points on the photograph of the cross-section, and average thickness of the foamed layer was taken as height of foaming.

One having a height of foaming of 1.1 mm or more is evaluated as “O” and one having a height of foaming of less than 1.1 mm or one that is blistered and is not worth measuring is evaluated as “x”.

### (5) Appearance of Foaming

A laminate obtained in Example or Comparative Example was cut into a piece of 10 cm×10 cm and was allowed to stand for 360 seconds in a perfect oven (PH-102 type manufactured by Espec) heated at 120° C. to achieve foaming. Thereafter, the sample was taken out and cooled to room temperature in the air. The size of the foamed cells was projected from the lower part with a digital microscope (HDM-2100 manufactured by Scalar Corporation). After all the area of the foamed cells within a square range of 1.3 cm×1.3 cm was measured, an average thereof was calculated. One having an average value exceeding 0.8 mm² or more or one that is blistered and has bad appearance was evaluated as bad appearance (x) and one having an average value of less than 0.8 mm² was evaluated as good appearance (O).

### (6) Microwave Oven Suitability

After a laminate obtained in Example or Comparative Example was shaped into a cup shape, it was allowed to stand for 360 seconds in a perfect oven (PH-102 type manufactured by Espec) heated at 120° C. to prepare a laminate after foaming for microwave oven suitability evaluation. About 300 cc of water at ordinary temperature was poured into the laminate after foaming and a microwave treatment was performed for 8 minutes using a microwave oven (NE-EH212 manufactured by Panasonic Corporation) having an output power of 750 W. Thereafter, the laminate was taken out and cooled to room temperature in the air and the condition of the foamed layer of the laminate was evaluated. One having no protrusion generated on the surface and no problem in surface gloss was judged as “O” and one having large protrusion generated on the surface or one that is not worth evaluating due to insufficient foaming was judged as “x”.

The following Table 1 shows the resin species used in Examples or Comparative Examples.

TABLE 1

| | MFR | | |
|---|---|---|---|
| | (g/10 | | |
| | min- | Density | |
| Resin | utes) | (g/cm³) | Reaction mode |
| (a) | 9.4 | 0.922 | high-pressure process low density polyethylene |
| (b) | 22.0 | 0.921 | high-pressure process low density polyethylene |
| (c) | 16.5 | 0.919 | ethylene-α-olefin copolymer |
| (d) | 14.0 | 0.918 | high-pressure process low density polyethylene |
| (e) | 4.0 | 0.923 | high-pressure process low density polyethylene |
| (f) | 8.4 | 0.918 | high-pressure process low density polyethylene |
| (g) | 16.0 | 0.923 | ethylene-α-olefin copolymer |

### Example 1

As a resin for use in the polyethylene-based resin layer (thermoplastic resin layer) (II), there was used medium-density polyethylene having MFR of 6 g/10 minutes, a density of 0.942 g/cm³, and a melting temperature of 130° C.

A paper substrate having a unit weight of 320 g/m² and a water content of 7% was subjected to corona treatment (30 W·min/m²) on one side thereof. Using a 90 mmϕ extruder (manufactured by Sumitomo Heavy Industries Modern, Ltd.), and an extrusion laminator having an air gap of 110 mm and a die effective width of 560 mm, the polyethylene was extrusion-laminated thereon at a thickness of 40 μm at a resin temperature of 320° C. and a processing speed of 50 m/min, thereby obtaining a laminate of the polyethylene-based resin layer (thermoplastic resin layer) (II) and the paper substrate.

Next, the paper substrate surface of the laminate was subjected to corona treatment (30 W·min/m²) on the side opposite to the side of the polyethylene-based resin layer (thermoplastic resin layer) (II). The polyethylene-based resin (A-1) shown in the following Table 2 was supplied to a single-screw extruder having a screw of a diameter of 90 mmϕ (manufactured by Sumitomo Heavy Industries Modern, Ltd.) and extrusion-laminated at a resin temperature of 320° C. and an air gap of 130 mm so that the thickness of the polyethylene-based resin layer (I) became 70 μm at a taking-over speed of 55 m/min or 65 m/min, thereby obtaining a laminate in which the polyethylene-based resin layer (I), the paper substrate, and the polyethylene-based resin layer (thermoplastic resin layer) (II) are laminated in the order. Moreover, in order to improve wettability, the surface of the polyethylene-based resin layer (I) was subjected to corona treatment (10 W·min/m²). The evaluation results of the obtained foamable laminate are shown in Table 3. Good results for appearance of foaming and height of foaming were obtained both at a processing speed of 55 m/min and at a processing speed of 65 m/min. Moreover, also in microwave oven suitability, no abnormalities were observed in the foamed layer.

### Example 2

A foamable laminate was obtained in the same manner as in Example 1 except that, as a resin for use in the polyethylene-based resin layer (I), the polyethylene resin (A-2) shown in the following Table 2 was used.

The evaluation results of the obtained foamable laminate are shown in Table 3. Good results for appearance of foaming and height of foaming were obtained both at a processing speed of 55 m/min and at a processing speed of 65 ml/min. Moreover, also in microwave oven suitability, no abnormalities were observed in the foamed layer.

### Example 3

A foamable laminate was obtained in the same manner as in Example 1 except that, as a resin for use in the polyethylene-based resin layer (I), the polyethylene resin (A-3) shown in the following Table 2 was used.

The evaluation results of the obtained foamable laminate are shown in Table 3. Good results for appearance of foaming and height of foaming were obtained both at a processing speed of 55 m/min and at a processing speed of 65 ml/min. Moreover, also in microwave oven suitability, no abnormalities were observed in the foamed layer.

### Example 4

A foamable laminate was obtained in the same manner as in Example 1 except that, as a resin for use in the polyethylene-based resin layer (I), the polyethylene resin (A-4) shown in the following Table 2 was used.

The evaluation results of the obtained foamable laminate are shown in Table 3. Good results for appearance of foaming and height of foaming were obtained both at a processing speed of 55 m/min and at a processing speed of 65 ml/min. Moreover, also in microwave oven suitability, no abnormalities were observed in the foamed layer.

### Example 5

A foamable laminate was obtained in the same manner as in Example 1 except that, as a resin for use in the polyethylene-based resin layer (I), the polyethylene resin (A-5) shown in the following Table 2 was used.

The evaluation results of the obtained foamable laminate are shown in Table 3. Good results for appearance of foaming and height of foaming were obtained both at a processing speed of 55 m/min and at a processing speed of 65 ml/min. Moreover, also in microwave oven suitability, no abnormalities were observed in the foamed layer.

### Comparative Example 1

A foamable laminate was obtained in the same manner as in Example 1 except that, as a resin for use in the polyethylene-based resin layer (I), the polyethylene resin (A-6) shown in the following Table 2 was used.

The evaluation results of the obtained foamable laminate are shown in Table 3. A good result for appearance of foaming was obtained at a processing speed of 55 m/min but bad foaming was observed at a processing speed of 65 m/min. Moreover, also in microwave oven suitability, large protrusion was generated on the surface of the foam.

### Comparative Example 2

A foamable laminate was obtained in the same manner as in Example 1 except that, as a resin for use in the polyethylene-based resin layer (I), the polyethylene resin (A-7) shown in the following Table 2 was used.

The evaluation results of the obtained foamable laminate are shown in Table 3. In microwave oven suitability, no abnormalities were observed in the foamed layer but height of foaming is low and, in the appearance of foaming, bad foaming was observed both at a processing speed of 55 m/min and at a processing speed of 65 ml/min.

### Comparative Example 3

A foamable laminate was obtained in the same manner as in Example 1 except that, as a resin for use in the polyethylene-based resin layer (I), the polyethylene resin (A-8) shown in the following Table 2 was used.

The evaluation results of the obtained foamable laminate are shown in Table 3. Bad foaming was observed both at a processing speed of 55 m/min and at a processing speed of 65 ml/min. Further, also in microwave oven suitability, large protrusion was generated on the surface of the foam.

### Comparative Example 4

A foamable laminate was obtained in the same manner as in Example 1 except that, as a resin for use in the polyethylene-based resin layer (I), the polyethylene resin (A-9) shown in the following Table 2 was used.

The evaluation results of the obtained foamable laminate are shown in Table 3. Bad foaming was observed both at a processing speed of 55 m/min and at a processing speed of 65 ml/min. Height of foaming was low and irregularities in appearance of foaming were severe. Moreover, in microwave oven suitability, the laminate was not worth evaluating due to insufficient foaming.

### Comparative Example 5

A foamable laminate was obtained in the same manner as in Example 1 except that, as a resin for use in the polyethylene-based resin layer (I), the polyethylene resin (A-10) shown in the following Table 2 was used.

The evaluation results of the obtained foamable laminate are shown in Table 3. Since blisters were generated on the foamed layer after foaming both at a processing speed of 55 m/min and at a processing speed of 65 ml/min and the appearance of foaming became bad, the laminate was not worth evaluating microwave oven suitability.

TABLE 2

| | | A-1 | | A-2 | A-3 | | A-4 | A-5 | |
|---|---|---|---|---|---|---|---|---|---|
| | | (a) | (b) | (a) | (a) | (b) | (a) | (a) | (c) |
| MFR | g/10 min | 9.4 | 22.0 | 9.4 | 9.4 | 22.0 | 9.4 | 9.4 | 16.5 |
| Density | g/cm³ | 0.922 | 0.921 | 0.922 | 0.922 | 0.921 | 0.922 | 0.922 | 0.919 |
| Mixing ratio | % by weight | 50 | 50 | 100 | 50 | 50 | 100 | 90 | 10 |
| Resin species | — | high- | high- | high- | high- | high- | high- | high- | ethylene- |
| | | pressure | pressure | pressure | pressure | pressure | pressure | pressure | α- |
| | | process low | process low | process low | process low | process low | process low | process low | olefin |
| | | density | density | density | density | density | density | density | copolymer |
| | | poly- | poly- | poly- | poly- | poly- | poly- | poly- | |
| | | ethylene | ethylene | ethylene | ethylene | ethylene | ethylene | ethylene | |

| | | | | | | |
|---|---|---|---|---|---|---|
| MFR after mixing | g/10 min | 14.4 | 9.4 | 14.4 | 9.4 | 9.9 |
| Density after mixing | g/cm³ | 0.922 | 0.922 | 0.922 | 0.922 | 0.922 |
| TREF (ratio of eluates | % by weight | 66 | 76 | 64 | 74 | 76 |
| at elution temperature | | | | | | |
| of 70° C. or higher) | | | | | | |
| Antioxidant | ppm | 0 | 0 | 300 | 300 | 0 |
| concentration | | | | | | |

| | | A-6 | A-7 | A-8 | A-9 | | A-10 |
|---|---|---|---|---|---|---|---|
| | | (d) | (e) | (f) | (g) | (d) | (b) |
| MFR | g/10 min | 14.0 | 4.0 | 8.4 | 16.0 | 14.0 | 22.0 |
| Density | g/cm³ | 0.918 | 0.923 | 0.918 | 0.923 | 0.918 | 0.921 |
| Mixing ratio | % by weight | 100 | 100 | 100 | 50 | 50 | 100 |
| Resin species | — | high- | high- | high- | ethylene- | high- | high- |
| | | pressure | pressure | pressure | α- | pressure | pressure |
| | | process low | process low | process low | olefin | process low | process low |
| | | density | density | density | copolymer | density | density |
| | | poly- | poly- | poly- | | poly- | poly- |
| | | ethylene | ethylene | ethylene | | ethylene | ethylene |

| | | | | | | |
|---|---|---|---|---|---|---|
| MFR after mixing | g/10 min | 14.0 | 4.0 | 8.4 | 15.0 | 22.0 |
| Density after mixing | g/cm³ | 0.918 | 0.923 | 0.918 | 0.921 | 0.921 |
| TREF (ratio of eluates | % by weight | 42 | 84 | 46 | 46 | 57 |
| at elution temperature | | | | | | |
| of 70° C. or higher) | | | | | | |
| Antioxidant | ppm | 0 | 0 | 0 | 0 | 0 |
| concentration | | | | | | |

TABLE 3

| | | | Example | | | | |
|---|---|---|---|---|---|---|---|
| | | | No | | | | |
| | | | 1 | 2 | 3 | 4 | 5 |
| | | | Resin species | | | | |
| Item | | | A-1 | A-2 | A-3 | A-4 | A-5 |
| Polyethylene resin layer (I) | MFR | g/10 min | 14.4 | 9.4 | 14.4 | 9.4 | 9.9 |
| (foamed layer) | Density | g/cm³ | 0.922 | 0.922 | 0.922 | 0.922 | 0.922 |
| | TREF (ratio of eluates at elution | % by weight | 66 | 76 | 64 | 74 | 76 |
| | temperature of 70° C. or higher) | | | | | | |
| | Antioxidant | ppm | — | — | 300 | 300 | — |
| Thermoplastic resin layer (II) | MFR | g/10 min | 6 | 6 | 6 | 6 | 6 |
| (inner layer) | Density | g/cm³ | 0.942 | 0.942 | 0.942 | 0.942 | 0.942 |
| Microwave oven suitability | 750 W/8 min | | ∘ | ∘ | ∘ | ∘ | ∘ |
| Height of foaming | Processing speed: 55 m | | ∘ | ∘ | ∘ | ∘ | ∘ |
| | Processing speed: 65 m | | ∘ | ∘ | ∘ | ∘ | ∘ |
| Appearance of foaming | Processing speed: 55 m | | ∘ | ∘ | ∘ | ∘ | ∘ |
| | Processing speed: 65 m | | ∘ | ∘ | ∘ | ∘ | ∘ |
| | | | Comparative Example | | | | |
| | | | No | | | | |
| | | | 1 | 2 | 3 | 4 | 5 |
| | | | Resin species | | | | |
| Item | | | A-6 | A-7 | A-8 | A-9 | A-10 |
| Polyethylene resin layer (I) | MFR | g/10 min | 14.0 | 4.0 | 8.4 | 15.0 | 22.0 |
| (foamed layer) | Density | g/cm³ | 0.918 | 0.923 | 0.918 | 0.921 | 0.921 |
| | TREF (ratio of eluates at elution | % by weight | 42 | 84 | 46 | 46 | 57 |
| | temperature of 70° C. or higher) | | | | | | |
| | Antioxidant | ppm | — | — | — | — | — |
| Thermoplastic resin layer (II) | MFR | g/10 min | 6 | 6 | 6 | 6 | 6 |
| (inner layer) | Density | g/cm³ | 0.942 | 0.942 | 0.942 | 0.942 | 0.942 |

| | | | | | | |
|---|---|---|---|---|---|---|
| Microwave oven suitability | 750 W/8 min | x | ∘ | x | x | x |
| Height of foaming | Processing speed: 55 m | ∘ | x | x | x | x |
| | Processing speed: 65 m | ∘ | x | x | x | x |
| Appearance of foaming | Processing speed: 55 m | ∘ | x | x | x | x |
| | Processing speed: 65 m | x | x | x | x | x |

From the above, it was revealed that, in a polyethylene-based resin composition for a foamable laminate, which forms a polyethylene-based resin layer (I) for foaming on at least one side of a paper substrate, by specifying the properties of the polyethylene-based resin (A) contained in the composition to the ranges defined in the present invention, foamed cells having sufficient height and good appearance (foamed layer) are obtained by heating with good productivity and also excellent microwave oven suitability is obtained.

While the present invention has been described in detail and with reference to specific embodiments thereof, it will be apparent to one skilled in the art that various changes and modifications can be made therein without departing from the spirit and scope thereof. The present application is based on Japanese Patent Application No. 2016-037385 filed on Feb. 29, 2016, and the contents are incorporated herein by reference.

1: A polyethylene-based resin composition comprising a polyethylene-based resin (A) satisfying properties (a-1) to (a-3):
(a-1) a melt flow rate MFR as measured in accordance with JIS K7210:1999, at 190° C., and a load of 21.18N, is 6 g/10 minutes or more and less than 20 g/10 minutes,
(a-2) a density as measured in accordance with JIS K7112:1999 at a test temperature of 23° C. is from 0.920 to 0.930 g/cm³, and
(a-3) a fraction of eluates at an elution temperature of 70° C. or higher is from 47 to 83% by weight in the elution curve obtained by a temperature rising elution fractionation (TREF) with o-dichlorobenzene.

2: The polyethylene-based resin composition according to claim 1, wherein the polyethylene-based resin (A) is at least one selected from the group consisting of a high-pressure radical polymerization process low-density polyethylene and an ethylene copolymer.

3: The polyethylene-based resin composition according to claim 2, comprising the high-pressure radical polymerization process low-density polyethylene as the polyethylene-based resin (A) and an ethylene-α-olefin copolymer.

4: The polyethylene-based resin composition according to claim 1, which is adapted for microwave oven cooking.

5: A foamable laminate comprising a polyethylene-based resin layer (I) on at least one side of a substrate comprising paper, wherein the polyethylene-based resin layer (I) comprises the polyethylene-based resin composition according to claim 1.

6: The foamable laminate according to claim 5, further comprising a thermoplastic resin layer (II) adapted to keep steam released from the substrate at the time of foaming on the other side of the substrate, wherein a thermoplastic resin (B) in the thermoplastic resin layer (II) satisfies property (b-1):
(b-1): a melting point (Tm(b)) falls within a range of from 100 to 140° C.

7: The foamable laminate according to claim 6, wherein a melting point (Tm(a)) of the polyethylene-based resin (A) and the melting point (Tm(b)) of the thermoplastic resin (B) satisfy property (b-2):
(b-2): Tm(b)−Tm(a) is 10° C. or more.

8: A method for producing a foamable laminate comprising a polyethylene-based resin layer (I) on at least one side of a substrate comprising paper, wherein the polyethylene-based resin layer (I) is formed by extrusion lamination of the polyethylene-based resin composition according to claim 1 on at least one side of the substrate.

9: The method for producing a foamable laminate according to claim 8, wherein a processing speed of the extrusion lamination is 55 m/minute or more.

10: A foamed processed paper, comprising the foamable laminate according to claim 5, wherein the polyethylene-based resin layer (I) of the foamable laminate is in a foamed state.

11: A heat insulating container, comprising the foamable laminate according to claim 5, wherein the polyethylene-based resin layer (I) of the foamable laminate is in a foamed state.
